(19) United States
(12) Patent Application Publication
(10) Pub. No.: US 2024/0415076 A1
(43) Pub. Date: Dec. 19, 2024

(54) SOD HARVESTER WITH ROLLER CONVEYOR

(71) Applicant: 1045929 Ontario Limited, Keswick (CA)

(72) Inventors: Gerardus J. BROUWER, Keswick (CA); Robert MILWAIN, Keswick (CA); Evan HOPKINS, Keswick (CA)

(21) Appl. No.: 18/736,960

(22) Filed: Jun. 7, 2024

Related U.S. Application Data
(60) Provisional application No. 63/508,710, filed on Jun. 16, 2023.

(51) Int. Cl. A01G 20/15

(52) U.S. Cl. CPC A01G 20/15

(57) ABSTRACT

A sod harvester includes (a) a harvester frame and (b) a conveyor system supported by the harvester frame. The conveyor system includes at least one first conveyor for transporting one or more slabs away from a cutting assembly and at least one second conveyor downstream of the at least one first conveyor for receiving the slabs from the at least one first conveyor and transporting the slabs downstream to a pick-up area along the at least one second conveyor for pick-up of the slabs by a stacking head. The second conveyor comprises a roller conveyor including a plurality of rollers arranged for engagement with an underside of the slabs for transporting the slabs to the pick-up area.

### CROSS-REFERENCE TO RELATED APPLICATIONS

This application claims the benefit of U.S. Provisional Patent Application No. 63/508,710 filed Jun. 16, 2023 and entitled “SOD HARVESTER WITH ROLLER CONVEYOR”, the entirety of which is hereby incorporated herein by reference.

### FIELD

The specification relates generally to sod harvesting.

### BACKGROUND

Sod slab harvesters typically operate by undercutting and chopping sod into slabs, transporting the slabs along a conveyor of the harvester, and transferring the slabs from the conveyor onto a pallet. When a pallet is sufficiently loaded with slabs, the loaded pallet is discharged from the sod harvester and replaced with an empty pallet for continued stacking of slabs. The discharged pallet can be transported to a location where the sod is to be stored, sold, or laid.

### SUMMARY

The following summary is intended to introduce the reader to various

aspects of the applicant's teaching, but not to define any invention.

According to some aspects, a sod harvester includes: (a) a harvester frame; (b) a cutting assembly mounted to the harvester frame for cutting sod into one or more slabs; and (c) a conveyor system supported by the harvester frame. The conveyor system includes at least one first conveyor for transporting the one or more slabs away from the cutting assembly and at least one second conveyor downstream of the at least one first conveyor for receiving the one or more slabs from the at least one first conveyor and transporting the one or more slabs downstream to a pick-up area along the at least one second conveyor. Each second conveyor comprises a roller conveyor including a plurality of rollers arranged for engagement with an underside of one or more respective slabs for transporting the one or more respective slabs to the pick-up area. The sod harvester further includes (d) a stacking head movably mounted to the harvester frame. The stacking head is moveable between a pick-up position above the pick-up area for picking up the one or more slabs from the pick-up area, and a drop-off position spaced apart from the pick-up position for depositing the one or more slabs at a drop-off area.

In some examples, each roller comprises a shaft extending along a respective roller axis, and at least one wheel member mounted on the shaft for engagement with the underside of the one or more respective slabs.

In some examples, each wheel member comprises a plurality of protrusions projecting radially outwardly relative to the shaft for engagement with the underside of the one or more respective slabs.

In some examples, the protrusions are resiliently deformable to inhibit build-up of slab material on the rollers.

In some examples, the roller conveyor includes a grate assembly for supporting the one or more slabs atop the roller conveyor while accommodating engagement of the rollers with the underside of the one or more slabs.

In some examples, the grate assembly includes a plurality of runners extending along the roller conveyor and spaced laterally apart from each other, each runner extending across a plurality of respective rollers for inhibiting the one or more slabs from being drawn between the respective rollers.

In some examples, the grate assembly includes a plurality of support cross-members extending laterally across the roller conveyor to support portions of the one or more slabs for cross-cutting by a cross-cut assembly of the stacking head.

In some examples, the stacking head includes a plurality of sod carriers comprising piercing members for piercing the one or more slabs to facilitate pick up of the one or more slabs at the pick-up area, and wherein the plurality of rollers are adapted to accommodate advancement of the piercing members below an upper extent of the rollers when piercing the one or more slabs.

According to some aspects, a sod harvester includes: (a) a harvester frame; (b) a cutting assembly mounted to the harvester frame for cutting sod into one or more slabs; and (c) a conveyor system supported by the harvester frame for transporting the one or more slabs from the cutting assembly to a pick-up area for pick-up of the one or more slabs by a stacking head of the sod harvester. The conveyor system comprising at least one roller conveyor extending along the pick-up area for transporting the one or more slabs thereto.

In some examples, the at least one roller conveyor includes a plurality of rollers.

In some examples, each roller comprises a shaft extending along a respective roller axis, and at least one wheel member mounted on the shaft for engagement with an underside of the slabs.

In some examples, each wheel member comprises a plurality of protrusions projecting radially outwardly relative to the shaft for engagement with the underside of the slabs.

In some examples, the protrusions are resiliently deformable to facilitate shedding of slab material from the rollers.

In some examples, the roller conveyor includes a support assembly for supporting the one or more slabs atop the roller conveyor while accommodating engagement of the rollers with the underside of the one or more slabs.

In some examples, the support assembly includes a plurality of runners extending along the roller conveyor and spaced laterally apart from each other.

In some examples, the support assembly includes a plurality of support cross-members extending laterally across the roller conveyor.

In some examples, the plurality of rollers are adapted to accommodate advancement of piercing members of the stacking head below an upper extent of the rollers when piercing the sod slabs for pick-up thereof.

According to some aspects, a method of harvesting sod slabs includes (a) cutting sod from a ground surface into one or more slabs using a cutting assembly of a sod harvester; (b) transporting the one or more slabs along a conveyor system of the sod harvester from the cutting assembly to a pick-up area, the transporting including engaging an underside of the one or more slabs with at least one roller conveyor of the conveyor system to position the one or more sod slabs at the pick-up area; and (c) operating a stacking head of the sod harvester to pick up the one or more slabs from the pick-up area and deposit the one or more slabs at a drop-off area spaced apart from the pick-up area.

In some examples, operating the stacking head to pick up the one or more slabs in (c) includes advancing piercing members of the stacking head to an elevation below an upper extent of the rollers for piercing the one or more sod slabs.

### BRIEF DESCRIPTION OF THE DRAWINGS

The drawings included herewith are for illustrating various examples of systems, methods, and apparatuses of the present specification and are not intended to limit the scope of what is taught in any way. In the drawings:

FIG. 1 is a partially schematic elevation view of portions of an example sod harvester;

FIG. 2 is a schematic plan view of the sod harvester of FIG. 1;

FIG. 3 is a perspective view of a conveyor portion of the sod harvester of FIG. 1;

FIG. 4 is a schematic front and side view of a roller of the conveyor portion of FIG. 3;

FIGS. 5A to 5D are schematic front and/or side views of other example roller configurations for the conveyor portion of FIG. 4;

FIG. 6 is a side elevation view of conveyor and stacking head portions of the sod harvester of FIG. 1, with the conveyor portions lowered relative to the stacking head portions;

FIG. 7 is a side elevation cross-section view of the conveyor and stacking head portions of FIG. 6, with the conveyor portions raised relative to the stacking head portions;

FIG. 8 is a close-up perspective view of a portion of the conveyor and stacking head portions shown in FIG. 6; and

FIG. 9 is a close-up perspective view of another portion of the conveyor and stacking head portions shown in FIG. 6.

### DETAILED DESCRIPTION

Various systems, apparatuses, or processes will be described below to provide an example of an embodiment of each claimed invention. No embodiment described below limits any claimed invention and any claimed invention may cover systems, processes, or apparatuses that differ from those described below. The claimed inventions are not limited to systems, apparatuses, or processes having all of the features of any one system, apparatus, or process described below or to features common to multiple or all of the systems, apparatuses, or processes described below. It is possible that a system, apparatus, or process described below is not an embodiment of any claimed invention. Any invention disclosed in a system, apparatus, or process described below that is not claimed in this document may be the subject matter of another protective instrument, for example, a continuing patent application, and the applicants, inventors, or owners do not intend to abandon, disclaim, or dedicate to the public any such invention by its disclosure in this document.

Sod harvesters operate to cut sod into slabs. The slabs are transported along a conveyor system to a pick-up area, and a stacking head picks up a layer of slabs at the pick-up area and transports the slabs from the conveyor system to a drop-off area having a pallet onto which the slabs are stacked. The process is repeated until the pallet is sufficiently loaded with slabs. The loaded pallet is then replaced with an empty pallet for continued stacking of slabs.

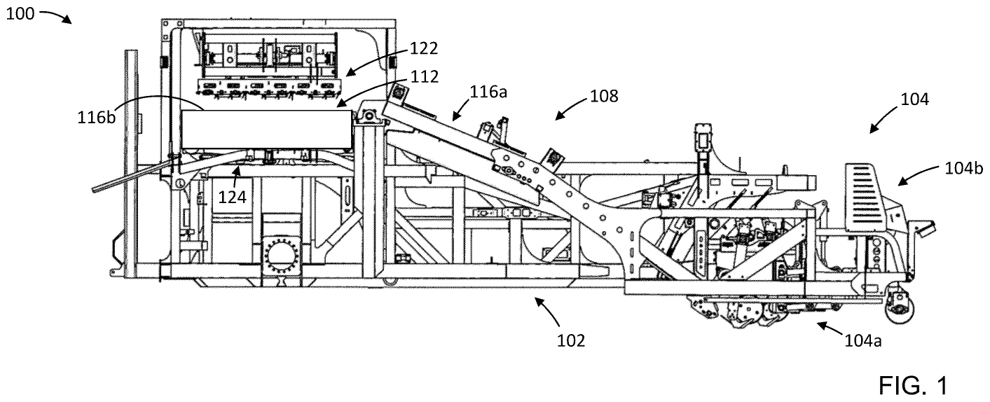

Referring to FIG. 1, an example sod harvester 100 for harvesting sod is illustrated. The sod harvester 100 includes a harvester frame 102 and a cutting assembly 104 mounted to the harvester frame 102 for cutting sod into slabs. The cutting assembly 104 has a plurality of cutting heads 104a (two cutting heads arranged side-by-side, in the example illustrated) for stripping corresponding sod strips from the ground, and a plurality of corresponding cut-off mechanisms 104b (two cut-off mechanisms arranged side-by-side, in the example illustrated) for cross-cutting the sod strips to a desired length to form the slabs.

The sod harvester 100 includes a conveyor system 108 having a plurality of conveyors supported by the harvester frame 102. In the example illustrated, the conveyor system 108 is operable to receive slabs from the cutting assembly 104, and to transport the slabs away from the cutting assembly 104 to a pick-up area 112 downstream of the cutting assembly 104 and along the conveyor system 108.

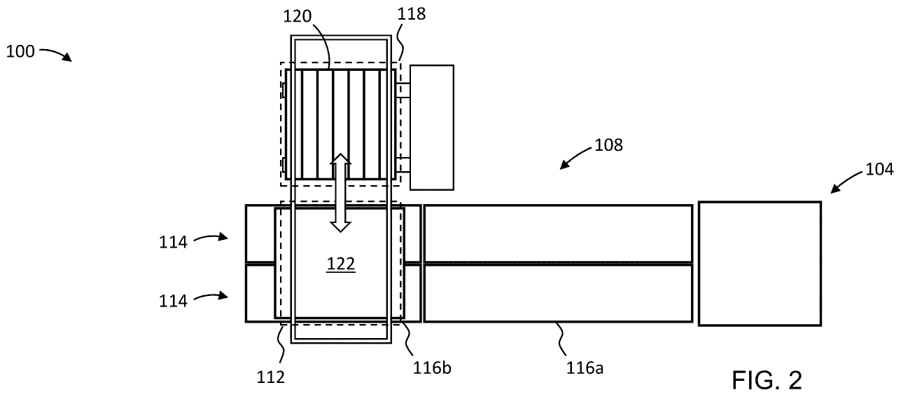

Referring to FIG. 2, in the example illustrated, the conveyor system 108 includes a plurality of conveyor sets 114 (two conveyor sets 114, in the example illustrated) arranged side-by-side and in alignment with corresponding cutting heads and cut-off mechanisms of the cutting assembly 104 for receiving corresponding slabs from the cutting assembly 104, and transporting the corresponding slabs to the pick-up area 112.

In the example illustrated, each conveyor set 114 includes at least one first conveyor 116a and at least one second conveyor 116b downstream of the first conveyor 116a. In the example illustrated, the first conveyor 116a is inclined, and the second conveyor 116b is generally horizontal. The first conveyor 116a is operable to receive slabs from the cutting assembly 104, and to transport the slabs to the second conveyor 116b for presentation of the slabs at the pick-up area 112, which is located along the second conveyors 116b in the example illustrated.

In the example illustrated, the sod harvester 100 includes a pallet station at the drop-off area 118. The pallet station is supported by the harvester frame 102 and spaced laterally apart from (and adjacent a side of) the pick-up area 112. The pallet station is operable to hold a pallet 120 for loading with slabs, to discharge the loaded pallet 120 to the ground, and load an empty pallet for further stacking.

In the example illustrated, the sod harvester 100 includes a stacking head 122 movably mounted to the harvester frame 102. The stacking head 122 is moveable between a pick-up position (shown in FIG. 2) above the pick-up area 112 for picking up one or more slabs from the pick-up area 112, and a drop-off position above the drop-off area 118 for depositing the one or more slabs onto a pallet 120 at the drop-off area 118. In the example illustrated, the stacking head 122 is translatable between the pick-up and drop-off positions through a gantry arrangement. In other examples, the stacking head 122 can be translatable between the pick-up and drop-off positions through a different mechanism, such as, for example, a robotic arm.

Referring to FIG. 1, in the example illustrated, the conveyor system 108 includes a slab lift 124 for lifting slabs at the pick-up area 112 toward the stacking head 122 for transfer thereto. In the example illustrated, the slab lift 124 is in the form of a scissor-style lift supported by the harvester frame 102 and operable to lift and lower the second (horizontal) conveyors 116b (defining the pick-up bed) toward and away from the stacking head 122. When lowered, the input end of each second conveyor 116b is in generally vertical alignment with the output end of each corresponding first conveyor 116a for receiving slabs from the first conveyor 116a. When lifted, each second conveyor 116b is raised toward the stacking head 122 to an elevation above the output end of the first conveyor 116a for presenting the slabs to the stacking head 122 (for pick-up of the slabs by the stacking head 122). In other examples, the second conveyors 116b may be vertically fixed relative to the harvester frame 102, and the stacking head 122 may be vertically translatable relative to the harvester frame 102 toward and away from the second conveyors 116b for pick-up of the slabs at the pick-up area 112.

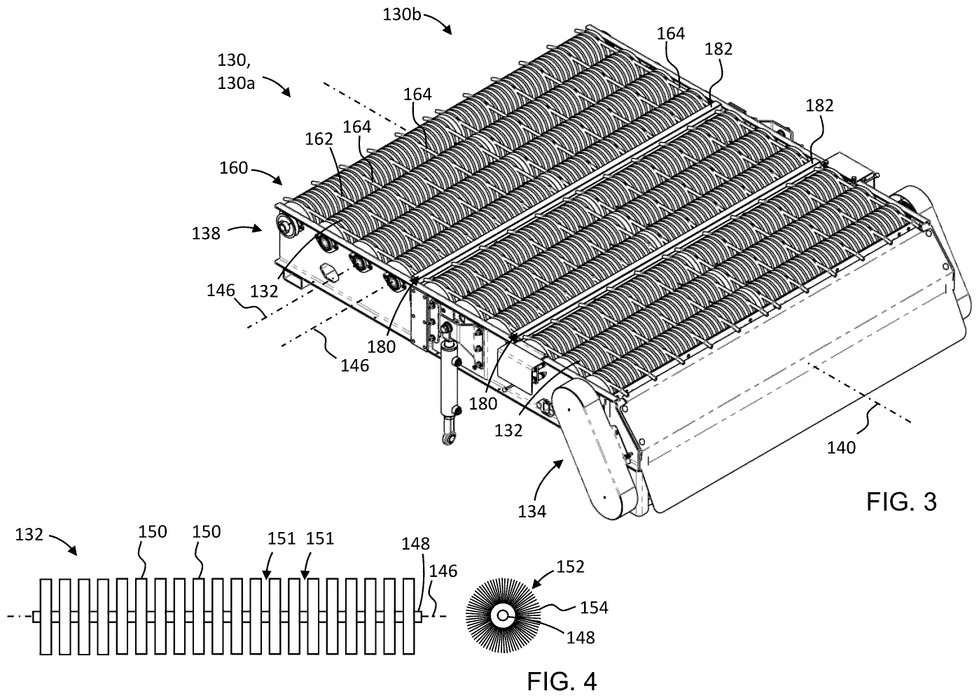

Referring to FIG. 3, in the example illustrated, each second conveyor 116b comprises a roller conveyor 130. In the example illustrated, each roller conveyor 130 includes a plurality of rollers 132 arranged for engagement with an underside of the slabs for translating the sod slabs along the roller conveyor 130 to the pick-up area 112 located along the roller conveyor 130. In the example illustrated, the roller conveyor 130 includes a drive system 134 operable to drive rotation of the plurality of rollers 132 for urging translation of the slabs along the roller conveyor 130 to the pick-up area 112. The drive system 134 can include at least one motor and a power train (e.g. chains, belts, gears, etc.) for transmitting power from the motor to the plurality of rollers 132.

In the example illustrated, the conveyor system 108 includes a plurality of the roller conveyors 130a, 130b arranged side-by-side and defining a pick-up bed from which the sod slabs are picked up by the stacking head 122. The pick-up bed has a conveyor frame 138 extending along a frame axis 140 between an upstream end for receiving sod slabs from the first conveyors 116a and a downstream end opposite the upstream end.

In the example illustrated, the rollers 132 of each roller conveyor 130 are rotatably mounted to the conveyor frame 138 for rotation about respective roller axes 146. The roller axes 146 are perpendicular to the frame axis 140 (and travel direction of the slabs). The roller axes 146 of each roller conveyor 130 are spaced apart from each other along the frame axis 140. In the example illustrated, each pair of axially adjacent rollers 132 are spaced apart from each other along the frame axis 140 by a roller gap.

Referring to FIG. 4, in the example illustrated, each roller 132 comprises a shaft 148 extending along a respective roller axis 146, and at least one wheel member 150 mounted on the shaft 148 for engagement with an underside of the sod slabs. In the example illustrated, each roller 132 comprises a plurality of wheel members 150 spaced apart from each other along the roller axis 146 by respective wheel spacings 151. The width of the wheel members 150 and the wheel spacings 151 can be selected to inhibit build-up of slab material (e.g. mud, clay, etc.) on the rollers 132 (e.g. by providing a plurality of relatively narrow wheel members 150 to facilitate shedding of the slab material).

In the example illustrated, each wheel member 150 comprises a plurality of protrusions 152 projecting radially outwardly relative to the shaft 148 for engagement with the underside of the sod slabs. In the example illustrated, the protrusions 152 are resiliently deformable, which can inhibit build-up of slab material on the rollers 132 (e.g. by facilitating shedding of the slab material through deflection of the protrusions 152). In the example illustrated, each roller 132 comprises a radial brush and the protrusions comprise brush bristles 154. The bristles can be formed from, for example, polymeric or metal strands.

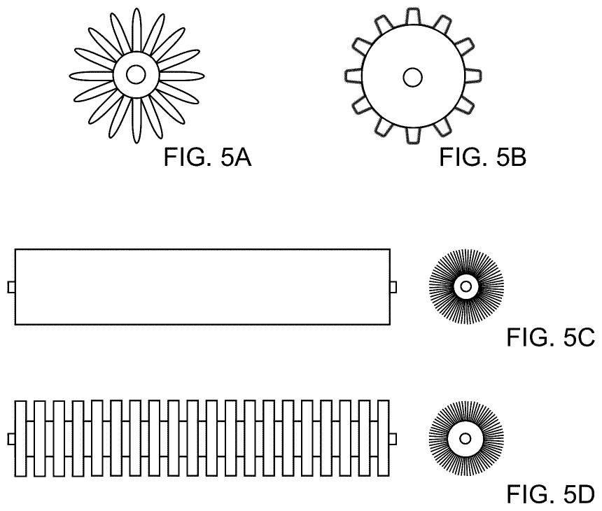

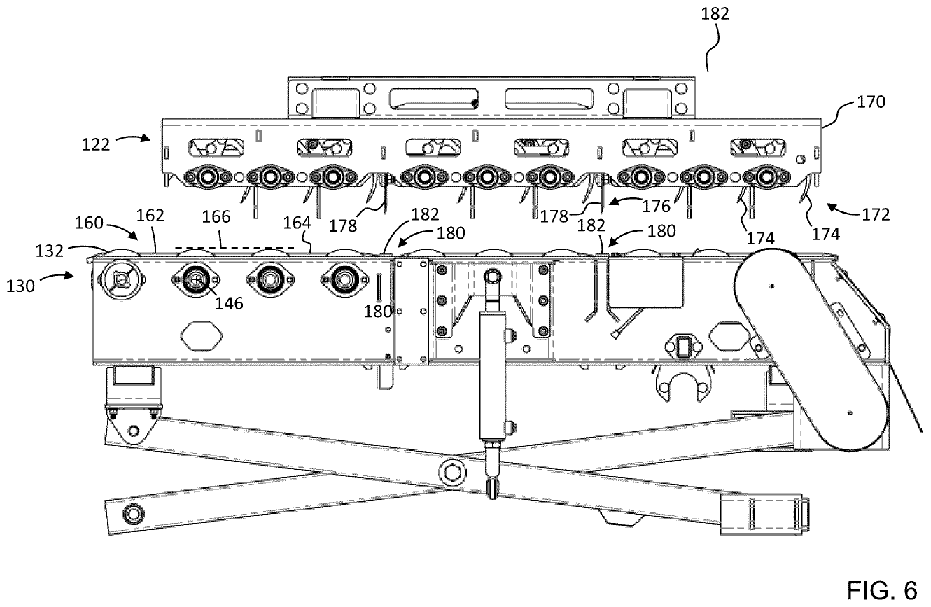

Referring to FIG. 5A, in some examples, the protrusions can comprise a plurality of fingers. The fingers can be formed of elastomer, rubber, or other resiliently deformable material, or can have geometry permitting resilient deformation (e.g. relatively thin, deflectable metal protrusions).

In some examples, the protrusions can be generally rigid, and can comprise, e.g. generally rigid teeth (see e.g. FIG. 5B), fingers, rods, spikes, etc.

In some examples, the rollers 132 can include tread to provide traction for gripping the underside of the slabs. The tread can be formed of a polymeric material (e.g. elastomer, rubber, or other material to facilitate gripping). The tread can be smooth, textured, cleated, ribbed, etc.

Referring to FIGS. 5C-5D, in some examples, each roller can comprise a single wheel member having a wheel hub extending over a length of the shaft. In some examples, the wheel member can have the protrusions (e.g. brush bristles) extending continuously along the roller axis and hub (see e.g. FIG. 5C), or, for example, arranged in annular sets spaced apart from each other at predetermined intervals along the hub (see e.g. FIG. 5D).

Referring to FIG. 3, in the example illustrated, the roller conveyor 130 includes an optional grate assembly 160 (also referred to as support assembly 160) to help support the slabs atop the rollers (e.g. in examples where the protrusions are resiliently deformable) and inhibit the slabs from being drawn between adjacent rollers 132 (e.g. in the roller gaps) while accommodating engagement of the rollers 132 with an underside of the slabs. In the example illustrated, the grate assembly 160 has an upper support surface 162 for engagement with the underside of the slabs. Referring to FIG. 6, in the example illustrated, the upper support surface 162 is vertically intermediate the roll axes 146 and an upper extent 166 of the plurality of rollers 132. In the example illustrated, an upper portion of the rollers 132 projects upwardly from the grate assembly to an elevation above the upper support surface 162 for engagement with the slabs.

Referring to FIG. 3, in the example illustrated, the grate assembly 160 includes a plurality of runners 164 defining the upper support surface 162. The runners 164 extend along the roller conveyor 130 and are spaced laterally apart from each other. Each runner 164 extends over and across a plurality of respective rollers 132 (and roller gaps therebetween) for inhibiting the slabs from being drawn between adjacent rollers (e.g. into the roller gaps). In the example illustrated, the runners 164 are laterally interspersed between the wheel members of respective rollers 132. In the example illustrated, each runner 164 is positioned laterally between wheel members 150 of respective rollers 132 (in respective wheel spacings or laterally between protrusions). In the example illustrated, the runners are configured to permit limited downward deflection of the runners in use (for example during pick up of slabs by the stacking head). This can help inhibit build-up of slab material on the runners, by, for example, facilitating shedding of the slab material. In the example illustrated, each runner 164 comprises an elongate rod extending between opposed ends supported by the conveyor frame 138.

Referring to FIG. 6, in the example illustrated, the upper support surface 162 of the grate assembly 160 is vertically nearer an upper extent 166 of the rollers 132 relative to the roller axes 146. In the example illustrated, each roller 132 has a roller radius. The upper support surface 162 is spaced vertically below the upper extent 166 of the rollers 132 by a vertical spacing.

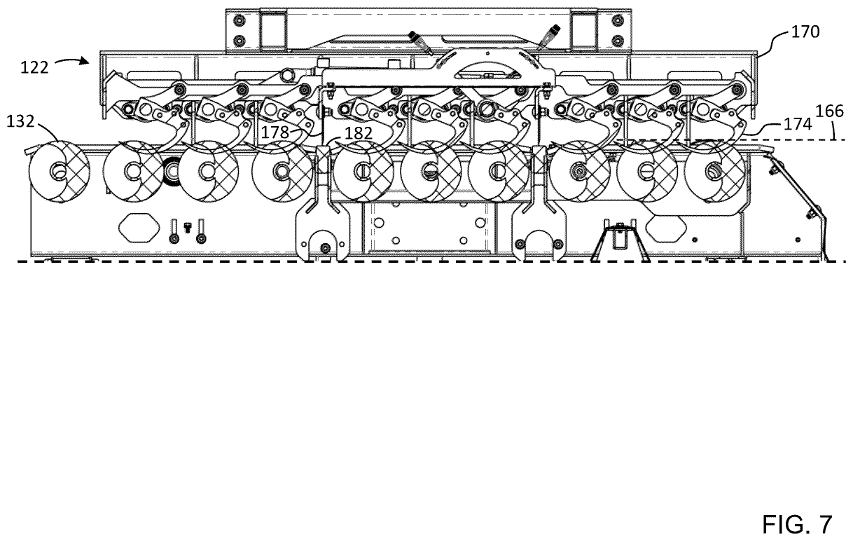

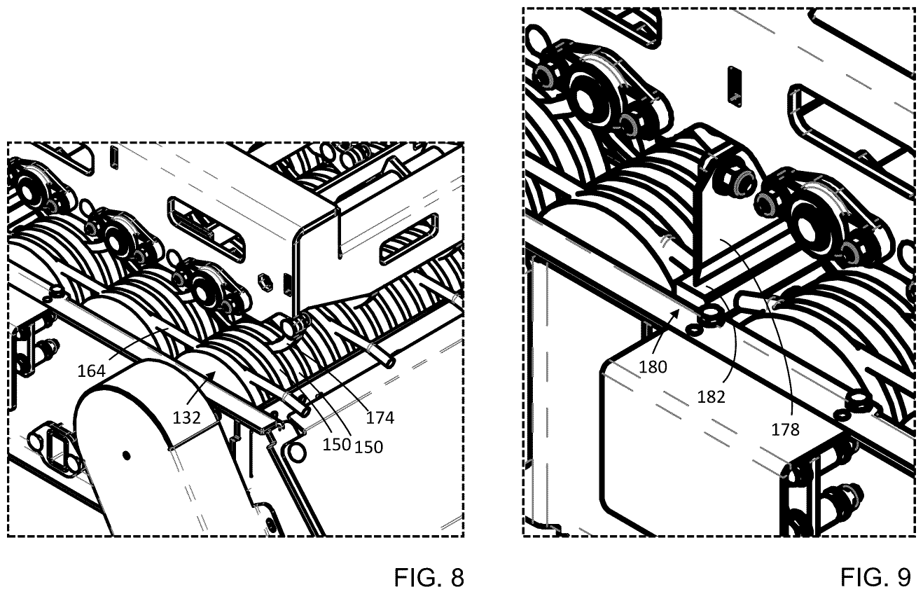

In the example illustrated, the stacking head 122 includes a head frame 170 and a plurality of sod carriers 172 mounted to the head frame 170 for picking up one or more sod slabs at the pick-up area 112. In the example illustrated, the sod carriers 172 comprise piercing members 174 for piercing the slabs to facilitate picking up of the slabs. Referring to FIG. 7, in the example illustrated, the plurality of rollers 132 are adapted to accommodate advancement of the piercing members 174 below the upper extent 166 of the rollers 132 when piercing the sod slabs. Referring to FIG. 8, in the example illustrated, when the stacking head 122 is in the pick-up position, the piercing members 174 are in alignment with respective wheel spacings to accommodate interference-free advancement of the piercing members 174 below the upper extent 166 of the rollers 132.

In some examples, the piercing members can be in alignment with lateral gaps between the protrusions. In some examples, the radial brush of the wheel members can accommodate advancement of the piercing members through the brush (i.e. between the bristles, or other protrusions) when piercing the sod slabs.

In the example illustrated, the piercing members 174 comprise a plurality of hooks pivotably mounted to the head frame 170. In the example illustrated, the hooks are pivotable relative to the head frame 170 between advanced and retracted positions. Referring to FIG. 7, when in the advanced position, the hooks project downwardly from an underside of the head frame 170 for engagement with and holding of one or more slabs through piercing of the slabs with the hooks. Referring to FIG. 6, when in the retracted position, the hooks are generally withdrawn relative to the head frame 170 for releasing and depositing the slabs held by the stacking head 122.

In the example illustrated, the stacking head 136 includes a cross-cut assembly 176 for cross cutting each initial slab received at the pick-up area 112 into a plurality of smaller slabs (e.g. cross cutting each 24-inch by 48-inch slab advanced to the pick-up area into three 24-inch by 16-inch slabs, or in other examples, into two 24-inch by 24-inch slabs). In the example illustrated, the cross-cut assembly 176 includes a pair of laterally extending blade assemblies 178 fixed to the head frame 170 and spaced apart from each other along the conveyor system 108 (when the stacking head is in the pick up position). Each blade assembly 178 has a cutting edge for cutting each initial slab into a plurality of smaller slabs when the slabs are brought into engagement with the stacking head 136. In other examples, the cross-cut assembly 176 may be configured differently (e.g. for cutting each initial slab into a different number of slabs and/or to different dimensions).

Referring to FIG. 3, in the example illustrated, the grate assembly 160 includes a plurality of cross-members 180 (two, in the example illustrated) extending laterally across the roller conveyors 130 to support the portions of the slabs being cross-cut by the cross-cut assembly 176. Referring to FIG. 6, each cross-member 180 is positioned between respective pairs of axially adjacent rollers 132 and is in axial alignment (along the roller conveyor 130) with a corresponding blade assembly 178, to support the portions of the slabs into which the blade assembly 178 is driven to facilitate cross-cutting with the blade assemblies 178. In the example illustrated, the quantity of cross-members 180 is equal to the quantity of blade assemblies 178.

In the example illustrated, each cross-member 180 has a cross-cutting support surface 182 atop which the portion of the slabs being cut by a respective blade assembly 178 can be supported. The cross-cutting support surface 182 is vertically intermediate the roll axes 146 and an upper extent 166 of the plurality of rollers 132. In the example illustrated, the cross-cutting support surface 182 is at an elevation below the upper support surface 162 defined by the runners 164. In the example illustrated, the runners 164 in each roller conveyor 130 are arranged in a plurality of axially spaced apart sets (three, in the example illustrated) separated by (and connected to) the cross-members 180, and are clear of the blade assemblies 178.

In the example illustrated, the sod harvester 100 is automated and includes a control system having one or more controllers and a plurality of sensors in communication with the controllers for controlling and coordinating operation of the sod harvester 100 (including the cutting assembly 104, conveyor system 108, roller drive mechanism, pallet station, stacking head 122, and other system components) to perform a continuous sod harvesting process as described herein.

1. A sod harvester, comprising:
a) a harvester frame;
b) a cutting assembly mounted to the harvester frame for cutting sod into one or more slabs;
c) a conveyor system supported by the harvester frame, the conveyor system including at least one first conveyor for transporting the one or more slabs away from the cutting assembly and at least one second conveyor downstream of the at least one first conveyor for receiving the one or more slabs from the at least one first conveyor and transporting the one or more slabs downstream to a pick-up area along the at least one second conveyor, each second conveyor comprising a roller conveyor including a plurality of rollers arranged for engagement with an underside of one or more respective slabs for transporting the one or more respective slabs to the pick-up area; and
d) a stacking head movably mounted to the harvester frame, the stacking head moveable between a pick-up position above the pick-up area for picking up the one or more slabs from the pick-up area, and a drop-off position spaced apart from the pick-up position for depositing the one or more slabs at a drop-off area.

2. The sod harvester of claim 1, wherein each roller comprises a shaft extending along a respective roller axis, and at least one wheel member mounted on the shaft for engagement with the underside of the one or more respective slabs.

3. The sod harvester of claim 2, wherein each wheel member comprises a plurality of protrusions projecting radially outwardly relative to the shaft for engagement with the underside of the one or more respective slabs.

4. The sod harvester of claim 3, wherein the protrusions are resiliently deformable to inhibit build-up of slab material on the rollers.

5. The sod harvester of claim 1, wherein the roller conveyor includes a grate assembly for supporting the one or more slabs atop the roller conveyor while accommodating engagement of the rollers with the underside of the one or more slabs.

6. The sod harvester of claim 5, wherein the grate assembly includes a plurality of runners extending along the roller conveyor and spaced laterally apart from each other, each runner extending across a plurality of respective rollers for inhibiting the one or more slabs from being drawn between the respective rollers.

7. The sod harvester of claim 5, wherein the grate assembly includes a plurality of support cross-members extending laterally across the roller conveyor to support portions of the one or more slabs for cross-cutting by a cross-cut assembly of the stacking head.

8. The sod harvester of claim 1, wherein the stacking head includes a plurality of sod carriers comprising piercing members for piercing the one or more slabs to facilitate pick up of the one or more slabs at the pick-up area, and wherein the plurality of rollers are adapted to accommodate advancement of the piercing members below an upper extent of the rollers when piercing the one or more slabs.

9. A sod harvester, comprising:
a) a harvester frame;
b) a cutting assembly mounted to the harvester frame for cutting sod into one or more slabs; and
c) a conveyor system supported by the harvester frame for transporting the one or more slabs from the cutting assembly to a pick-up area for pick-up of the one or more slabs by a stacking head of the sod harvester, the conveyor system comprising at least one roller conveyor extending along the pick-up area for transporting the one or more slabs thereto.

10. The sod harvester of claim 9, wherein the at least one roller conveyor includes a plurality of rollers.

11. The sod harvester of claim 10, wherein each roller comprises a shaft extending along a respective roller axis, and at least one wheel member mounted on the shaft for engagement with an underside of the slabs.

12. The sod harvester of claim 11, wherein each wheel member comprises a plurality of protrusions projecting radially outwardly relative to the shaft for engagement with the underside of the slabs.

13. The sod harvester of claim 12, wherein the protrusions are resiliently deformable to facilitate shedding of slab material from the rollers.

14. The sod harvester of claim 10, wherein the roller conveyor includes a support assembly for supporting the one or more slabs atop the roller conveyor while accommodating engagement of the rollers with the underside of the one or more slabs.

15. The sod harvester of claim 14, wherein the support assembly includes a plurality of runners extending along the roller conveyor and spaced laterally apart from each other.

16. The sod harvester of claim 14, wherein the support assembly includes a plurality of support cross-members extending laterally across the roller conveyor.

17. The sod harvester of claim 10, wherein the plurality of rollers are adapted to accommodate advancement of piercing members of the stacking head below an upper extent of the rollers when piercing the sod slabs for pick-up thereof.

18. A method of harvesting sod slabs, comprising:
a) cutting sod from a ground surface into one or more slabs using a cutting assembly of a sod harvester;
b) transporting the one or more slabs along a conveyor system of the sod harvester from the cutting assembly to a pick-up area, the transporting including engaging an underside of the one or more slabs with at least one roller conveyor of the conveyor system to position the one or more sod slabs at the pick-up area; and
c) operating a stacking head of the sod harvester to pick up the one or more slabs from the pick-up area and deposit the one or more slabs at a drop-off area spaced apart from the pick-up area.

19. The method of claim 18, wherein operating the stacking head to pick up the one or more slabs in (c) includes advancing piercing members of the stacking head to an elevation below an upper extent of the rollers for piercing the one or more sod slabs.
